(19) United States
(12) Patent Application Publication
(10) Pub. No.: US 2004/0258971 A1
(43) Pub. Date: Dec. 23, 2004

(54) Fuel cell power generator

(76) Inventors: Hisaaki Gyoten, Osaka (JP); Takeshi Tomizawa, Ikoma-shi (JP); Teruhisa Kanbara, Osaka (JP)

Correspondence Address: MCDERMOTT, WILL & EMERY, 600 13th Street, N.W., WASHINGTON, DC, 20005-3096, US

(21) Appl. No.: 10/835,589

(22) Filed: Apr. 30, 2004

(30) Foreign Application Priority Data
May 2, 2003 (JP) JP2003-127266

(51) Int. Cl. H01M 8/04; H01M 8/10

(52) U.S. Cl. 429/26; 429/32

(57) ABSTRACT

A fuel cell power generator is described which is capable of maintaining the electroconductivity of the cooling medium at a low level for a long period of time thereby preventing the metal components contacting the cooling medium from corroding, and functioning without causing any harm to power generation. Embodiments include a fuel cell power generator having a fuel cell, a cooling medium pipe, a heat exchanger and a means for circulating cooling the medium. These elements are arranged so that the formation of a conductive network electrically connecting the fuel cell, the pipe, the heat exchanger and the circulating means is prevented.

### FIELD OF THE INVENTION

The present invention relates to a fuel cell power generator suitable for use in home cogeneration systems, power generators for vehicles, etc. and more particularly to a fuel cell power generation system including a fuel processor, a fuel cell stack, a cooling system and a heat exchanger.

### BACKGROUND

A polymer electrolyte fuel cell is expected to be available for consumer use including home use because it operates at around room temperature. The fuel cell not only generates power at its installation site, but also can be incorporated into a cogeneration system which utilizes waste heat.

Fuel cells typically have a series of units cells arranged in a stack to produce electricity from a fuel. The basic unit cell of a polymer electrolyte fuel cell is a membrane electrolyte assembly (MEA) composed of a hydrogen ion conductive polymer electrolyte membrane having a thickness of 30 to 100 μm and a pair of gas diffusion electrodes sandwiching the polymer electrolyte membrane.

The gas diffusion electrode is formed by applying, on a gas diffusion substrate, a mixture made of electrolyte resin having hydrogen ion conductivity like the polymer electrolyte membrane and carbon powder having particulate noble metal dispersed on the surface thereof which later serves as a catalyst for electrochemical reaction. The mixture constitutes a catalyst reaction layer. Electric power is generated by feeding a fuel gas and an oxidant gas to the gas diffusion electrodes.

In practice, the MEA is sandwiched between separators to produce a unit cell. A plurality of the unit cells are typically arranged serially to give a stack of unit cells. The stack of unit cells is placed between end plates, which is then clamped at both ends to give a fuel cell stack.

Between an end plate and a separator adjacent to the end plate is placed a current collector plate for efficiently collecting the generated electric current. The current collector plate and the end plate are typically insulated by an insulating material. The current collector plate is usually made of metal, and the end plate is also mostly made of metal for mechanical strength.

The separator is required to have electron conductivity, air-tightness and corrosion resistance, and thus is made of a material having the above properties. Usually, a carbonaceous material or a metal material is used.

Between an MEA and a separator is disposed a gas sealant, i.e. a gasket, such that the gas sealant encompasses the gas diffusion electrode in order to prevent the fuel and oxidant gases supplied to the cell from leaking outside of the cell and from mixing with each other.

On each of the MEAs, manifolds for supplying and removing the reactant gases are formed such that the manifolds run through the separators (internal manifold). In the fuel cell, the chemical energy of the reactant gases is partly converted into electricity and the remaining of the chemical energy is converted into heat inside the fuel cell stack.

In order to carry the heat generated inside the fuel cell stack outside of the cell stack for efficient use thereof and to maintain the temperature of the fuel cell stack constant, a cooling water is typically circulated inside the stack. Manifolds for cooling water are also formed, similar to those for the reactant gases, such that the manifolds run through the separators. The cooling water having passed through the stack is usually expelled outside the fuel cell stack to a heat exchanger to remove heat and then is brought back to the stack for circulation.

Other than the manifold as described above which is an “internal manifold”, there is another type of manifold called an “external manifold”, which is disposed at each of the sides of a fuel cell stack. External manifolds provide the reactant gases to each unit cell from the sides of the fuel cell stack. There are also external manifolds for supplying and removing cooling water. Fluids such as reactant gases and cooling water are fed from the outside of the stack to the inside of the stack through pipes connected to the end plates and the current collector plates.

Usually, the end plates of the fuel cell stack are fixed to a fuel cell power generator. The fuel cell power generator includes, other than the fuel cell stack, a fuel processor for producing hydrogen from a fossil fuel such as natural gas, humidifiers for humidifying the reactant gases to be supplied to the fuel cell stack, an inverter for converting generated direct electrical current to alternating electrical current, a heat exchanger for adjusting the temperature of the fuel cell stack, a hot-water storage tank for the efficient use of generated heat and a controller for controlling the whole system. Each of the above elements constituting the fuel cell power generator is attached to the body or cabinet of the fuel cell power generator.

FIG. 6 shows a schematic diagram illustrating the structure of the above-described fuel cell power generator. As shown in the figure, fuel processor 102 produces a fuel gas composed mainly of hydrogen from raw material such as natural gas. The produced fuel gas is passed to a humidifier 105 and then to a fuel cell stack 101. The fuel processor 102 comprises: a reformer 103 for producing a reformed gas from raw material; and a carbon monoxide converter 104 for producing carbon dioxide and hydrogen through the reaction of carbon monoxide contained in the reformed gas with water.

An air supplier 106 supplies an oxidant gas, i.e. air, to the fuel cell stack 101 through another humidifier 107. A pump 109 supplies cooling water for cooling down stack 101S in the fuel cell stack 101 through cooling water pipe 108. The supplied cooling water circulates throughout stack 101S to reach the cooling water pipe 108. Between the fuel cell stack 101 and the pump 109 is arranged a heat exchanger 110 through which the cooling water pipe 108 is in contact. During power generation, the heat of the cooling water having passed through the fuel cell stack 101 is transferred through a heat exchanging plate 110A in the heat exchanger 110 to cooling water pumped by a circulating pump 111, which is then transported through a heat removing pipe 112 to a storage tank 113.

In the fuel cell stack 101, cooling water circulates throughout the inside of the stack 101S to enhance cooling efficiency. The use of pure water having extremely low electroconductivity as the cooling water prevents the transmission of high voltage generated in the fuel cell stack to the cooling system through the cooling water. Reducing the conductivity of the cooling water reduces the corrosion of the metals of the cooling system such as cooling water pipe 108, pump 109 and heat exchanging plate 110A in the heat exchanger 110, etc.

Japanese Laid-Open Patent Publication No. 2000-297784 discloses a fuel cell power generator in which a material capable of absorbing and desorbing ions of cooling water upon application of an electric potential is disposed in the cooling water. This absorbing material helps to prevent ions from leaching from materials constituting an element of a cooling system into the cooling water. Further, Japanese Laid-Open Patent Publication No. 2001-155761 discloses a technique in which an inlet of a fuel cell for cooling water and an outlet therefor are short-circuited and connected to a negative electrode of the fuel cell.

In the fuel cell power generators described above, an opening must be formed in the cooling system to supply cooling water. If an opening is formed in some part of the cooling system, however, impurities tend to enter from the opening, leading to an increased electroconductivity of the water. The impurities causing the increase of electroconductivity of cooling water not only enter from the opening, but also occur within the fuel cell power generator itself. For example, the leaching of ions from the cooling water pipe and the separators causes an increased electroconductivity of the water.

A metal portion of the cooling system contacting the cooling water has a certain electric potential relative to the cooling water. The electric potential of the cooling water, however, has a gradient between a positive electrode (oxidant electrode) and a negative electrode (fuel electrode) of the fuel cell stack. For this reason, if at least two metal portions of different electrical potentials contacting the circulating cooling water conduct an electric current when the electroconductivity of cooling water starts to increase, the surface of one of the metal portions will corrode to release positive ions. This further increases the conductivity of the cooling water, creating a deleterious spiral of accelerating the corrosion and the release of ions. Once such a deleterious spiral occurs, not only will the cooling system be contaminated, but the fuel cell stack 101 will be gradually degraded as well.

As explained above, the electroconductivity of the cooling water abruptly changes when operating a conventional power generator over time. It is therefore necessary to provide a device for continuously monitoring the electroconductivity of the cooling water to track the electroconductivity. In addition, an ion absorbing material has its absorbing capability limit, and once the material is disposed, the replacement thereof will be difficult. This further requires an operation such as the application of a reverse electric potential to restore the material. Moreover, it is difficult to dispose the material on the heat exchanging plate of the heat exchanger, and short-circuiting the outlet and inlet of the heat exchanger will create another problem of the corrosion of the metal portion.

### SUMMARY OF THE DISCLOSURE

An advantage of the present invention is a fuel cell power generator capable of preventing or reducing the corrosion of electrically conductive components thereof, such as a different conductive materials contacting the cooling system. Another advantage of the present invention is a power generator which can suppress the concentration of impurity ions in a cooling medium used therein, and to function with minimal interference due to any ion impurity that may leach into the cooling medium.

These and other advantages are achieved in part by a fuel cell power generator having one or more components electrically insulated from each other. For example, a power generator can include a fuel cell stack; a cooling medium path (pipe) in fluid connection with the fuel cell stack for containing a cooling medium; a heat exchanger in contact with the cooling medium path for removing heat from the cooling medium (water); and a circulating system (e.g. a pump) for circulating the cooling medium through cooling medium path. In accordance with one aspect of the present invention, at least two of these elements are electrically insulated from each other, i.e., at least the fuel cell stack, cooling medium path, heat exchanger or circulating system are electrically insulated from each other.

Preferably at least two electrically conductive components, which are in contact with the cooling medium, are electrically isolated. These components can be an electronic conductive portion of the fuel cell stack, an electronic conductive portion of the cooling medium path, an electronic conductive portion of the heat exchanger, and an electronic conductive portion of the circulating system. That is at least two electrically conductive elements or portions that are in contact with cooling medium selected from the group consisting of an electronic conductive portion of the fuel cell stack, an electronic conductive portion of the cooling medium path, an electronic conductive portion of the heat exchanger, and an electronic conductive portion of the circulating system are electrically insulated.

Embodiments of the present invention include: a fuel cell stack comprising a stack of unit cells, a pair of current collectors and a pair of end plates, each of the unit cells comprising a hydrogen ion conductive electrolyte membrane, a pair of electrodes sandwiching the hydrogen ion conductive electrolyte membrane and a pair of separators sandwiching the electrodes; a heat exchanger comprising a heat removing path connected thereto and a heat exchanging plate for recovering heat from the cooling medium flowing in the cooling medium path. Advantageously, either the heat exchanging plate or the heat removing path can be grounded to reduce electrical leakage.

Another embodiment of the present invention includes a fuel cell power generator comprising: a fuel cell stack comprising a stack of unit cells, a pair of current collectors and a pair of end plates, each of the unit cells comprising a hydrogen ion conductive electrolyte, a pair of electrodes sandwiching the hydrogen ion conductive electrolyte and a pair of separators sandwiching the electrodes; a cooling medium path for circulating a cooling medium inside the fuel cell stack; a heat exchanger in contact with the cooling medium path and having a heat removing path connected thereto and a heat exchanging plate for recovering heat from the cooling medium; a circulating system for circulating cooling medium through the cooling medium path; and an interruption unit for interrupting a flow of the cooling medium disposed along any portion of the cooling medium path.

Advantageously, the fuel cell power generator can include a plurality of interruption units. It is effective that the interruption unit is positioned at both the inlet and outlet side of the heat exchanger, but the invention is not limited thereto. It is further advantageous to have at least one of the heat exchanging plate or the heat removing path connected to ground.

According to the fuel cell power generator of the present invention having the above described structure, it is possible to minimize, if not prevent, the metal portions of the power generator contacting the cooling medium from corroding and to minimize any increase in the electroconductivity of the cooling medium over a long period of time.

Another aspect of the present invention includes a method for preventing the corrosion of electrically conductive components of a fuel cell power generator, such as the heat exchanging plate in the heat exchanger, by interrupting the flow of the cooling medium through the power generator. Advantageously the interruption effectively prevents the electric potential of the cooling medium from being transmitted to another conductive component of the power generator, such as the heat exchanging plate in the heat exchanger.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various respects, all without departing from the invention. Accordingly, the drawings and description are to be regarded as illustrative in nature, and not as restrictive.

### BRIEF DESCRIPTION OF THE DRAWINGS

The various features and advantages of the present invention will become more apparent and facilitated by reference to the accompanying drawings, submitted for purposes of illustration and not to limit the scope of the invention, where the same numerals represent like structure and wherein:

FIG. 1 is a diagram illustrating a structure of a fuel cell power generator according to a first embodiment of the present invention.

FIG. 2 is a diagram showing a structure of a stack 1S of a fuel cell 1 in FIG. 1 and an electric potential of each of the unit cells in the stack.

FIG. 3 is a diagram illustrating a structure of a fuel cell power generator according to a second embodiment of the present invention.

FIG. 4 is a diagram schematically showing a structure of an interruption unit 41A used in a second embodiment.

FIG. 5 is a graph comparatively showing the relation between operation time and electric resistance of cooling water in fuel cell power generators of Examples and Comparative Example.

FIG. 6 is a diagram illustrating a structure of a conventional fuel cell power generator.

### DETAILED DESCRIPTION OF THE DISCLOSURE

The present invention addresses the problems associated with the efficient operation of a fuel cell power generator over a long period of time. Fuel cell power generator comprise several components that are made of different electrically conductive materials that are in electrical contact with each other through at least the cooling medium. Circulating the cooling medium through the various components of the fuel cell power generator can cause a conductive network. Since the several components of the power generator have different voltage potentials, the cooling medium can facilitate corrosion of the various metal components, which in turn can increase the conductivity of the medium, which further encourages corrosion resulting in an escalating decay of the generator over time. The present invention advantageously reduces or prevents the forming of a conductive network due to cooling medium circulating throughout the fuel cell power generator by electrically insulating the conductive components of the generator, such as the electronic conductive members constituting the fuel cell stack, the cooling medium path, the heat exchanger, and the cooling medium circulating system from each other. In short, an aspect of the present invention is to prevent the formation of a conductive network among at least the fuel cell stack, the heat exchanger and the circulating system due to the cooling medium by electrically insulating their electrically conductive portions from each other.

The present invention advantageously reduces or prevents an abrupt increase in the electroconductivity of the cooling medium (water or a solution thereof) over a long period of time and the attendant corrosion of the electrically conductive portions contacting the cooling medium by electrically insulating the electronic conductive portions contacting the cooling medium from each other and/or interrupting the flow of the cooling medium so as to prevent an electrical path along the cooling medium. By practicing certain embodiments of the present invention, it is also possible to greatly enhance the reliability of the fuel cell power generator. Accordingly, the fuel cell power generator in accordance with the present invention is suitable for use in home cogeneration systems, power generators for vehicles, etc.

In one embodiment of the present invention, a fuel cell power generator is composed of: a fuel cell stack; a cooling medium path (pipe) in fluid connection with the fuel cell stack for containing a cooling medium (water or a solution thereof); a heat exchanger in contact with the cooling medium path for removing heat from the cooling medium; and a circulating system (e.g. an electric pump) for circulating the cooling medium through cooling medium path. In accordance with certain aspects of the present invention, at least one component of the generator is electrically isolated from the cooling medium.

The present invention contemplates several arrangements that electrically isolates various components of the fuel cell power generator. For example, it is effective to electrically insulate the components of the generator by electrically insulating at least one portion of the cooling medium path, e.g. an electrically insulating part is disposed along at least one portion of the cooling medium path. Specifically, it is effective that the cooling path is at least partly made of an insulating material. It is further effective that the fuel cell stack is physically attached to the cooling medium path by an electrically insulating material, e.g. the fuel cell stack is fixed to the cabinet of the fuel cell power generator by a member comprising an insulating material. Another example of electrically insulating the various components of the generator is by providing one or more interruption units along the cooling medium path for interrupting the flow of the cooling medium. The interruption units preferably reduce the continuity of the electrical potential carried by the cooling medium. This can be achieved by causing the cooling medium to free fall thereby reducing the continuity of medium.

The various components of the fuel cell generator typically comprise electrically conductive members. For example, the fuel cell stack can be composed of: a stack of unit cells, a pair of current collectors and a pair of end plates, in which each of the unit cells comprises a hydrogen ion conductive electrolyte membrane, a pair of electrodes sandwiching the hydrogen ion conductive electrolyte membrane and a pair of separators sandwiching the electrodes. The heat exchanger can be composed of: a heat removing path (pipe) connected thereto and a heat exchanging plate for recovering heat from the cooling medium. The heat removing path can be further connected to a hot water supplier or hot water storage tank. Several of the electrically conductive members of the various fuel cell power generator components can be electrically insulated from the cooling medium, as discussed above.

However, if the inlet for the cooling medium and the outlet therefor in the heat exchanging plate of the heat exchanger are connected and made of the same metal, for example, the difference in electric potential between cooling medium (water) passing through the inlet and cooling medium passing through the outlet is relatively small. Accordingly, when a combination of electronic conductive portions contacting the cooling medium cooperatively exhibit a single function such as heat exchanging in the heat exchanging plate described above, the insulation of these electronic conductive portions are not as effective as electrically conductive members having different functions.

Conversely, when electronic conductive portions have different functions, respectively, such as in the case of the heat exchanger and the pump which have the desperate functions of heat exchanging and circulating cooling medium, they are preferably insulated from each other.

In the case of the outermost separator and the current collector in the fuel cell stack, although they have different shapes and are made of different materials, they have the same function, that is, to collect electricity. In such a case, a portion where electric current is functionally conducted is insulated from another component of the generator.

In another aspect of the present invention, it is also effective that the fuel cell power generator further comprises an electric leakage prevention means for preventing an electric short between the fuel cell stack and the heat removing path. That is, an electromotive force generated in the fuel cell stack is prevented from leaking to the heat removing pipe. For example, an electric leakage can be prevented by providing an electric connection between the heat exchanging plate and ground or by providing an electric connection between the heat removing path and ground. In other words, the electric leakage prevention means can be, for example, to connect at least one of the heat exchanging plate or the heat removing pipe to ground.

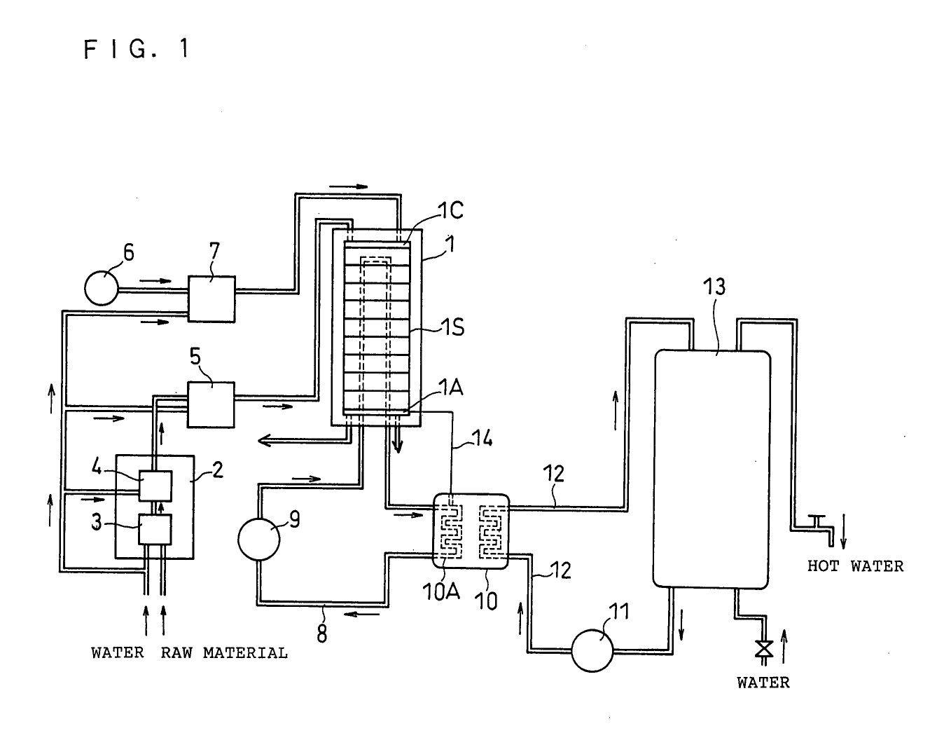

Certain features and advantages of certain embodiments of the present invention will become more apparent and facilitated by reference to the accompanying drawings, where FIG. 1 shows the structure of a fuel cell power generator according to a first embodiment of the present invention. As shown, the fuel cell power generator includes fuel cell stack 1, which in turn includes a stack of a plurality of unit cells 1S, and current collectors and end plates disposed at both ends of the stack of unit cells 1S (hereinafter referred to as “stack 1S”). Each of the unit cells comprises a hydrogen ion conductive electrolyte membrane and a pair of electrodes sandwiching the membrane and a pair of electronic conductive separators sandwiching the electrodes. The fuel cell power generator further comprises cooling pipe 8 for circulating a cooling medium through stack of unit cells 1S, heat exchanger 10 for recovering waste heat from the cooling medium having passed through fuel cell stack 1 which has a heat removing pipe and a heat exchanging plate for transferring heat of the cooling water, and pump 9 for circulating the cooling medium. Although any cooling medium can be used in the present invention, purified and/or distilled water is preferred. Solutions of purified water are also contemplated as cooling media such as a water antifreeze solution. For this embodiment, purified water as the cooling medium will be described.

In the fuel cell power generator of the present invention, fuel processor 2 first produces a fuel gas composed mainly of hydrogen from a raw material such as natural gas. The produced fuel gas is then fed into fuel cell stack 1 through humidifier 5. Fuel processor 2 comprises reformer 3 for producing a reformed gas and carbon monoxide converter 4 for producing carbon dioxide and hydrogen through the reaction of carbon monoxide contained in the reformed gas with water.

Although humidifier 5 and another humidifier 7 are located remote from fuel cell stack 1 in FIG. 1, it is effective to place humidifiers 5 and 7 adjacent to fuel cell stack 1 and to utilize heat released from heat removing pipe 12 of heat exchanger 10, which will be described later, for humidification. In some cases, the portion contacting the cooling water of the humidifiers may be deemed to be the electronic conductive portion of the present invention because cooling water passes through or is in contact with the humidifiers.

Air supplier 6 feeds an oxidant gas, i.e. air, to fuel cell stack 1 through humidifier 7. Pump 9 supplies cooling water for cooling down fuel cell stack 1 through cooling water pipe 8. The cooling water circulates throughout stack 1S.

Disposed on cooling water pipe 8 is located heat exchanger 10. During power generation, waste heat of cooling water having passed through fuel cell stack 1 is transferred through heat exchanging plate 10A in heat exchanger 10 to cooling water pumped by circulating pump 11, which is then transported through heat removing pipe 12 to storage tank 13. In fuel cell stack 1, cooling water is circulated throughout the inside of stack 1S to enhance cooling efficiency. The storage tank may be a hot water supplier or hot water storage tank because the same effect can be obtained by using the structure of the present invention.

Heat exchanger 10 comprises cooling water pipe 8 and heat exchanging plate 10A connected thereto. Heat exchanging plate 10A is made of metal that is preferably highly effective in exchanging (conducting) heat.

In accordance with embodiments of the present invention, the fuel cell power generator is arranged to prevent a conductive network from occurring in the fuel cell power generator. This phenomenon ordinarily occurs because the cooling medium is ordinarily capable of conducting current and it contacts different metals components of the generator having different voltage potentials, effectively forming a local electrochemical cell bridging the different metal components. As the electrical conductivity of the medium increases and/or when the potential differences increases, the propensity for corrosion also increases. Once a conductive network is formed, the circulation of cooling water having a certain electroconductivity causes some of the metal portions in the generator to become noble and other to become base resulting in the corrosion of the electronic conductive portions. The present invention is intended to address this problem.

For example, cooling water pipe 8 is preferably made of an electrical insulating material with preferably high heat resistance, such as resin or ceramic. To further reduce the voltage potential of cell stack 1S with the heat exchanger, electrical connection (metal wire) 14 is connected between collector plate 1A and heat exchanger 10 or plate 10A.

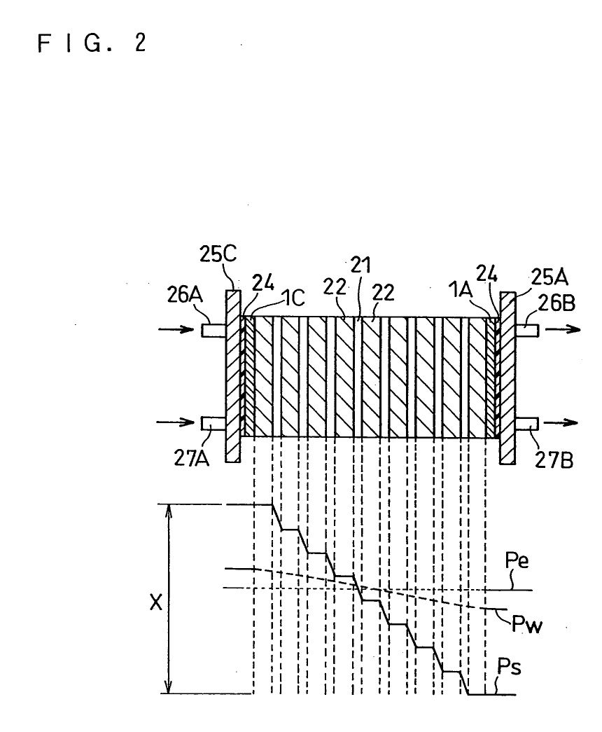

FIG. 2 shows the structure of a fuel cell stack that can be employed in stack 1S in fuel cell stack 1 of FIG. 1 and an electric potential of each of the unit cells in stack 1S.

In the power generating portion of stack 1S in fuel cell stack 1, membrane electrolyte assemblies (MEAs) 21, each comprising a polymer electrolyte membrane and a pair of gas diffusion electrodes sandwiching the polymer electrolyte membrane, are stacked alternately with conductive separator plates 22 to form a stack. At the ends of the stack are disposed a current collector plate 1C and end plate 25C with insulating plate 24 interposed therebetween and another set of current collector plate 1A and end plate 25A with insulating plate 24 interposed therebetween.

End plates 25A and 25C are fastened with insulating bolts and nuts, which are not shown in the figure. The unit cells are electrically connected with each other in series by conductive separator plates 22. This makes it possible to prevent the gases or cooling water from leaking from any contact portion between membrane electrolyte assembly 21 and separator plate 22.

The end plate 25C disposed at the positive electrode (oxidant electrode) side has oxidant gas inlet 26A and cooling water inlet 27A. The end plate 25A disposed at the negative electrode (fuel electrode) side has fuel gas outlet 26B and cooling water outlet 27B. Although only the inlet for oxidant gas and the outlet for fuel gas are shown in FIG. 2, in practice, an inlet and an outlet for fuel gas and an inlet and an outlet for oxidant gas are provided. In the structure of the present invention, end plates 25A and 25C can be made of stainless steel which is easily moldable and relatively inexpensive.

Separator plates 22, except those that are disposed at the ends of stack 1S in fuel cell stack 1, have a gas flow channel for supplying oxidant gas to one gas diffusion electrode (positive electrode) on one surface thereof and another gas flow channel for supplying fuel gas to the other gas diffusion electrode (negative electrode) on the other surface thereof. Separator plate 22 that is disposed at every, for example, two unit cells has a cooling water flow channel for cooling down each of the unit cells formed thereon.

Cooling water enters from cooling water inlet 27A into stack 1S, passes through the separator plates that are disposed at every two unit cells to cool down stack 1S and then exits from outlet 27B into heat exchanger 10. In heat exchanger 10, the cooling water is cooled down by exchanging heat, which is again sent to stack 1S. In the cooling water circulation system composed mainly of cooling water pipe 8 and pump 9, the cooling water contacts the metal portions of end plates 25A and 25C, as well as those of heat exchanging plate 10A.

In the case of using pure water as the cooling water or a water/antifreeze solution, the medium initially has a low electroconductivity, but its electroconductivity gradually increases due to impurities from the opening (not shown in the figure) of the cooling water system and those leaching from the materials constituting the cooling water circulation system.

The lower part of FIG. 2 schematically shows the electric potential of each of the separators corresponding to the position of the elements constituting stack 1S. The electric potential of the stack (separators) is represented by “Ps”, and that of the cooling water is represented by “Pe” and “Pw”. The “Pe” represents the electric potential of the cooling water during shutdown of the fuel cell (i.e. when the stack does not have an electromotive force) or that when the cooling water has an extremely high conductivity due to ion contamination. The “Pw” represents the electric potential of the cooling water when the cooling water has minimal contamination by leached ions (i.e. when the contamination is prevented by the present invention).

Between the current collector plates 1A and 1C exists an electric potential difference of several ten volts (V) or more, which varies depending on the number of the unit cells. The electric potential of the cooling water passing throughout the inside of stack 1S is controlled by this electric potential. Accordingly, in the cooling water, a large electric potential difference as shown by X in FIG. 2 occurs. It is, in other words, a difference between the highest electric potential and the lowest electric potential. The cooling water present within cooling water pipe 8, connecting pump 9, stack 1S, and heat exchanger 10 has an electric potential corresponding to the distance from two points of inlet 27A and outlet 27B.

The metal portions contacting the cooling water have an electric potential corresponding to the cooling water that contacts the metal portions. If an electric current is conducted between such metal portions, the electric potentials of the metal portions will be equal. Accordingly, an electric potential higher than that of the cooling water occurs in one metal portion, and an electric potential lower than that of the cooling water occurs in the other metal portion.

When the electroconductivity of the cooling water increases, metal ions leach from the metal portion having an electric potential higher than that of the cooling water into cooling water, as described earlier. As a result, the ion conductivity of the cooling water further increases, which accelerates the corrosion of the metal portions.

In one embodiment of the present invention, the metal portions contacting the cooling water in the cooling system are insulated from each other to prevent the occurrence of a significant electric potential difference between the metal portion and the cooling water and thus the corrosion of the metal portions. For this reason, cooling water pipe 8 connecting heat exchanging plate 10A, stack 1S and pump 9 is made of an insulating material such as an insulating resin or ceramic.

Stack 1S is sandwiched between the end plates 25A and 25C, which is fastened with insulating bolts and nuts. In this embodiment, the bolts and nuts are made of ceramic, although they can be made of metal if a member made of an insulating material such as heat-resistant resin, heat-resistant rubber or ceramic is placed between end plate 25A and the bolt and nut and between end plate 25C and the bolt and nut.

Moreover, stack 1S of fuel cell stack 1 is preferably housed in a case (not shown in the figure) with an insulating material placed between end plate 25A and the case and between end plate 25C and the case to prevent the end plate and the case from being electrically connected with each other.

With the structure as described above, the metal portions in the fuel cell power generator, namely, end plates 25A and 25C as well as heat exchanging plate 10A, can be electrically insulated. This effectively prevents the acceleration of the corrosion of the metal portions resulting from electric potential differences thereof.

Connecting heat exchanging plate 10A of heat exchanger 10 to the ground prevents the transmission of electric potential of the cooling water to the hot water system side, and thus prevents heat removing pipe 12 from corroding. In this case, both the positive electrode (oxidant electrode) and the negative electrode (fuel electrode) in fuel cell stack 1 should not be connected to ground. Additionally, corrosion prevention can be further enhanced by connecting heat removing pipe 12 to the ground.

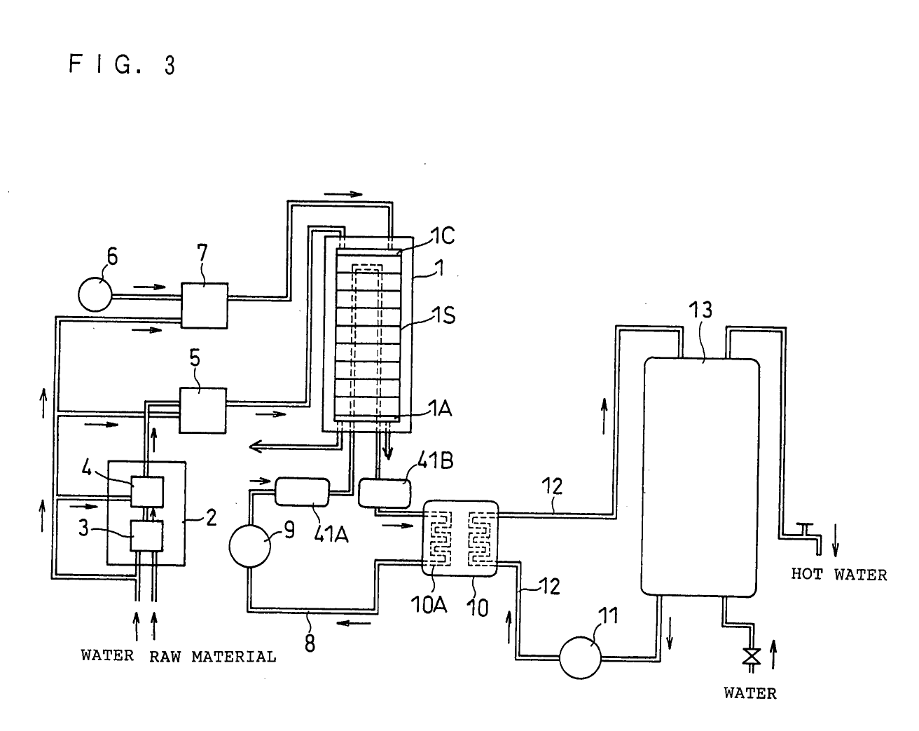

The fuel cell power generator according to the second embodiment of the present invention is now described. FIG. 3 shows the structure of the fuel cell power generator according to the second embodiment of the present invention. This fuel cell power generator comprises fuel cell stack 1, cooling water pipe 8, heat exchanger 10, and pump 9, analogous to the structure shown in FIG. 1. FIG. 3. further includes two interruption units 41A and 41B for interrupting the flow of cooling water in the fuel cell power generator. The interruption units break or reduce any conductive network that may be formed among the generator components due to cooling medium.

As seen from FIG. 3, the interruption units 41A and 41B are disposed along cooling water pipe 8 between pump 9 and fuel cell stack 1 and between fuel cell stack 1 and heat exchanger 10, respectively. In the figure, two interruption units are provided for illustrating preferred placement of a pair of interruption units. It is understood, however, that the present inventive power generator does not require an interruption unit and can further include only one of such units. It is believed that the insulation effect increases an with increasing number of the interruption units, however, and in a separate embodiment of the present invention, one or more interruption units are disposed along the cooling medium path.

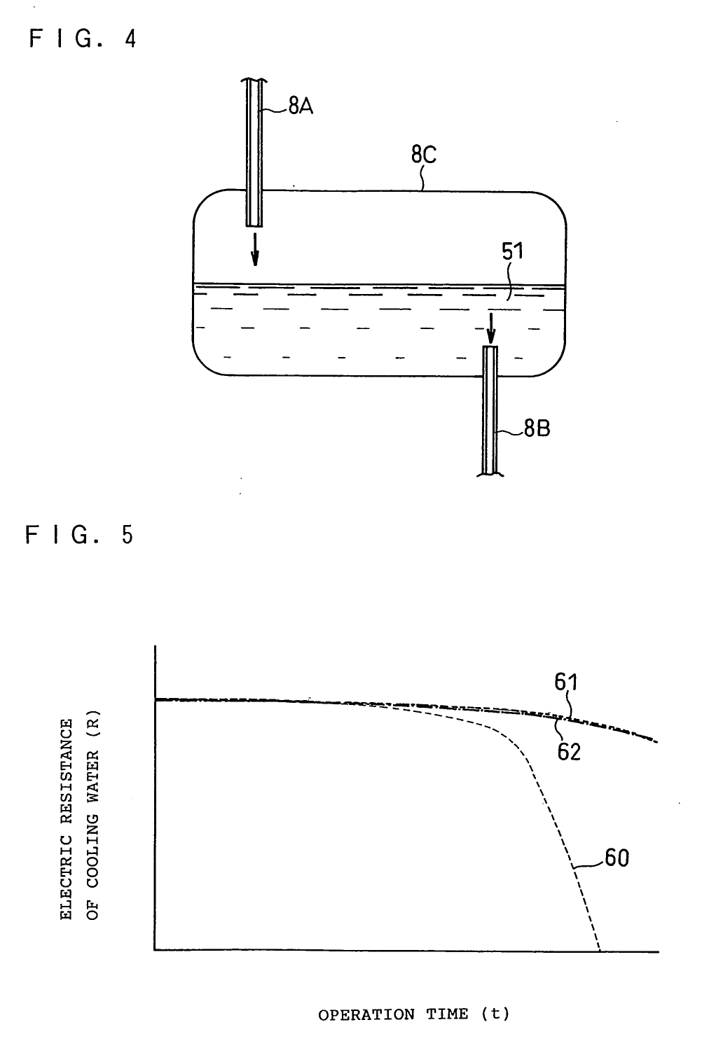

FIG. 4 schematically shows interruption unit 41A used in this embodiment of the present invention. Interruption unit 41B also has the same structure. As shown in FIG. 4, interruption unit 41 comprises container 8C, inlet pipe 8A and outlet pipe 8B both of which are connected to container 8C. Inlet pipe 8A is connected to the upper part of container 8C and outlet pipe 8B is connected to the lower part of container 8C. Preferably, container 8C of interruption unit 41A is hermetically sealed. In one aspect of the present invention, the interruption unit operates as a siphon to remove the cooling medium from the lower part as by pipe 8B.

In operation, the cooling water of FIG. 3 is circulated by pump 9, which forces the medium to inlet pipe 8A of interruption unit 41A and then to container 8C thereof. The medium is then discharged from outlet pipe 8B into fuel cell stack 1. The opening of the inlet pipe 8A is formed in the upper part of container 8C which is situated above the surface of cooling water 51. The flow of the cooling water is interrupted between pipe 8A and 8B, e.g., at least at surface 51. As shown, the interruption unit operates to disrupt the continuity of the cooling medium by causing the medium to fee-fall from the top of container 8C. The suspension of cooling medium in air reduces its electrical conductivity thereby insulating the medium from the components before the interruption unit with those after it.

By locating interruption unit(s) 41A and/or 41B having the structure described above along cooling water pipe 8 between fuel cell stack 1 and the heat exchanger and/or between pump 9 and fuel cell stack 1, an electrical connection (i.e. a conductive network) among fuel cell stack 1, heat exchanger 10 and pump 9 due to the flow of the cooling water is interrupted. This avoids or minimizes the creation of an electric potential difference between heat exchanging plate 10A and the cooling water resulting from the electric potential of the fuel cell stack 1, thus preventing the heat exchanging plate from corroding. With the use of this structure, inlet pipe 8A and the outlet pipe 8B can be made of inexpensive metal.

In the case where cooling water pipe 8 connecting heat exchanger 10 and fuel cell stack 1 is long, the placement of only interruption unit 41A between pump 9 and fuel cell stack 1 may not prevent all the effect of the electric potential. Under these circumstances, it is preferred to include interruption unit 41B on cooling water pipe 8 between heat exchanger 10 and fuel cell stack 1 as well as interruption unit 41A between pump 9 and fuel cell stack 1. Although not show in the figure, the connection of the heat exchanging plate 10A to the ground offers the same effect as the first embodiment.

Each of the unit cells constituting the above-described fuel cell stack 1 comprises a pair of gas diffusion electrodes, each composed of a gas diffusion layer and a catalyst reaction layer, and a polymer electrolyte membrane sandwiched therebetween. The gas diffusion layer can be made of carbon paper, carbon cloth produced by weaving a flexible material such as carbon fiber, or carbon felt formed by adding an organic binder to a mixture of carbon fiber and carbon powder.

The following examples are intended to further illustrate certain preferred embodiments of the invention and are not limiting in nature. Those skilled in the art will recognize, or be able to ascertain, using no more than routine experimentation, numerous equivalents to the specific substances, procedures and arrangements described herein.

### EXAMPLES 1, 2 and COMPARATIVE EXAMPLE

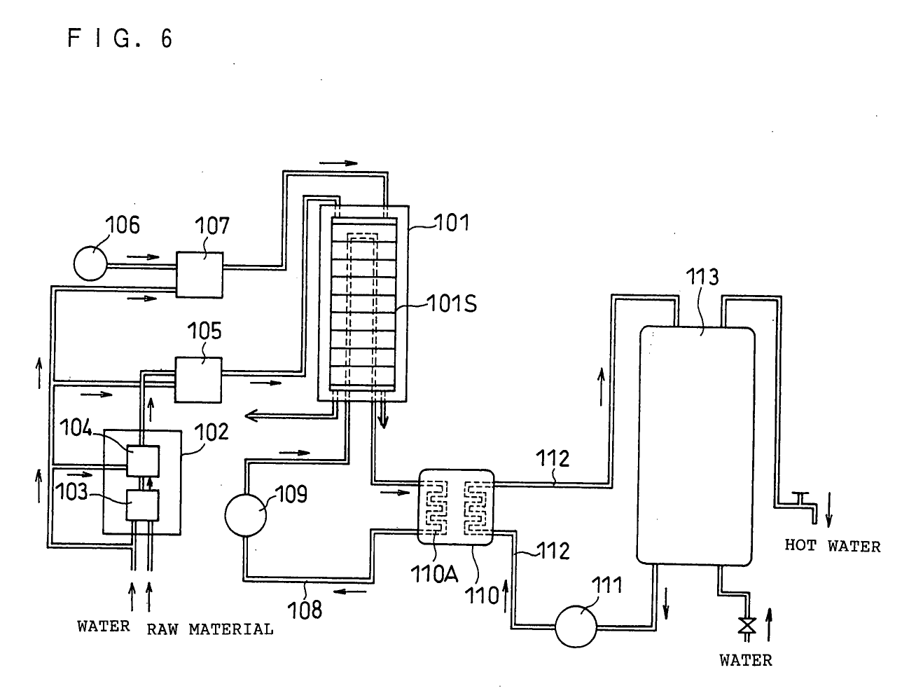

A fuel cell power generator 1 having the structure shown in FIG. 1 (EXAMPLE 1), a fuel cell power generator 2 having the structure shown in FIG. 3 (EXAMPLE 2) and a fuel cell power generator for comparison having the structure shown in FIG. 6 (COMPARATIVE EXAMPLE) were produced here.

First, the unit cells of a fuel cell stack 1 were produced. A platinum catalyst was supported on the surface of a carbon powder (DENKA BLACK FX-35, manufactured by Denki Kagaku Kogyo Kabushiki Kaisha) to give a catalyst body with 50 wt % of platinum. The catalyst body was dispersed in an alcohol solution (Flemion FSS-1, manufactured by Asahi Glass Co., Ltd.) of a polymer electrolyte to give a slurry.

A piece of carbon paper (TGP-H-090, manufactured by Toray Industries, Inc.) with a thickness of 200 μm was immersed in an aqueous dispersion of polytetrafluoroethylene (PTFE), which was dried and subjected to heat treatment to give a gas diffusion layer with water repellency.

The slurry was applied to one face of the gas diffusion layer, which was dried to give a gas diffusion electrode comprising an electrode reaction layer and the gas diffusion layer. The amount of platinum per unit area of the gas diffusion electrode was about 0.5 g. In the above manner, two gas diffusion electrodes were produced.

Then, a polymer electrolyte membrane (NAFION 112, manufactured by E.I. Du Pont de Nemours & Co. Inc., USA) was sandwiched between a pair of the gas diffusion electrodes such that the electrode reaction layers of the gas diffusion electrodes face inward toward each other. The electrodes were then hot-pressed at a temperature of about 110° C. under a pressure of about 2.5 MPa for about 30 seconds to give a membrane electrolyte assembly (MEA). The gas diffusion electrode had an area (i.e. electrode area) of about 25 cm2.

Meanwhile, carbon powders were cold-pressed to form a plate. The plate was impregnated with phenol resin, which was cured to give a resin-impregnated plate having an improved gas sealing property. The surface of this plate was etched to form a gas channel thereon to give a conductive separator. Then, manifold apertures for supplying and removing the fuel gas, those for supplying and removing the oxidant gas, and those for supplying and removing the cooling water were formed on the periphery of the gas channel of the separator.

Subsequently, stack 1S of the fuel cell stack 1 having the structure shown in FIG. 2 was produced. A gasket made of silicon rubber as the gas sealant was placed around the MEA produced above, and the separator 22 was then placed thereon. In this manner, ten MEAs were stacked with separators 22 interposed therebetween. The separators that were disposed at every two MEAs had a cooling water flow channel. Thereby, a stack of unit cells was obtained.

At both ends of the thus-produced stack were disposed current collectors 1C and 1A, each obtained by plating a plate made of copper with gold, insulating plates 24 and end plates 25A and 25C (made of stainless steel) in this order. The fuel cell stack was then fixed at a pressure of about 20 kgf/cm2. Each of the current collectors also had manifold apertures for the fuel gas, those for the oxidant gas and those for the cooling water formed thereon.

End plates 25A and 25C were fastened with insulating bolts and nuts, which are not shown in the figure. The unit cells were electrically connected with each other in series by conductive separator plates 22. Thereby, the contact portion between the elements such as the membrane electrolyte assembly 21 and separator 22 was completely sealed.

Reactant gas inlet 26A and cooling water inlet 27A were formed in end plate 25C and reactant gas outlet 26B and cooling water outlet 27B were formed in end plate 25B such that they respectively corresponded to the manifold apertures described above. Although FIG. 2 shows only one inlet for reactant gas (oxidant gas) and one outlet for reactant gas (fuel gas), in practice, an inlet and an outlet for fuel gas and an inlet and an outlet for oxidant gas were provided.

In fuel cell stack 1 thus produced, the manifold aperture for fuel gas was connected to fuel processor 2 with humidifier 5 placed therebetween, and the manifold aperture for oxidant gas was connected to air supplier 6 with humidifier 7 placed therebetween. The manifold apertures for cooling water of stack 1S were connected to cooling water pipe 8 connecting heat exchanger 10 and pump 9.

Cooling water pipe 8 used here was a pipe made of resin (i.e. electrical insulating material). This prevented a conductive network due to the cooling water circulating among the fuel cell, the heat exchanger and the pump. Thereby, the fuel cell power generator 1 having the structure shown in FIG. 1 was completed (EXAMPLE 1).

As the second embodiment of the present invention (EXAMPLE 2), fuel cell power generator 2 having the structure shown in FIG. 3 was produced in the same manner as the fuel cell power generator 1 was produced except that interruption units 41A and 41B for interrupting the flow of the cooling water, each having the structure shown in FIG. 4, were respectively located on cooling water pipe 8 between fuel cell stack 1 and heat exchanger 10 and between pump 9 and fuel cell stack 1.

For comparison (COMPARATIVE EXAMPLE), a fuel cell power generator for comparison having a conventional structure shown in FIG. 6 was produced.

EVALUATION

The fuel cell power generators produced above were evaluated in terms of corrosion of the metal portions during operation. A gas supplying system for supplying the gases, a power output system for setting and adjusting a load current to be drawn from the cell, and a heat adjusting system for adjusting the cell temperature and efficient use of waste heat were joined with each of the above produced fuel cell power generators, which was then continuously operated for the evaluation.

The current density in each unit cell was set to 0.3 A/cm2. As for the gas utilization rate, which indicates how much gas was used for electrode reaction relative to the gas supplied, the gas utilization rate for the fuel electrode was set to 70% and that for the oxidant electrode was set to 40%.

The power generation of the fuel cell is determined by the chemical formula: H2+½O2→H2O. If all the H2 introduced causes the above reaction, the utilization rate would be 100%. In practice, however, approximately 30% of the H2 introduced is left unreacted due to various reasons. In other words, that percentage of the H2 remains intact and is then discharged.

The cell temperature was set to 75° C. As for the reactant gases, pure hydrogen was supplied as the fuel gas, and air was supplied as the oxidant gas. As for the supply pressure of the reactant gases, the supply pressure of air was set to 0.2 kgf/cm2, and that of hydrogen was set to 0.05 kgf/cm2. The outlets were open to the air.

Pure water was used as the cooling water. During continuous operation of each of the fuel cell power generators, changes in cell performance and electroconductivity (i.e. electrical resistance) of the cooling water were continuously monitored. FIG. 5 shows a comparative graph of the operation time verses the electrical resistance of the cooling water of the fuel cell power generators of EXAMPLES 1 and 2 and COMPARATIVE EXAMPLE, which are respectively represented by the numerals 61, 62 and 60. The horizontal axis represents the operation time (t), and the vertical axis represents the electrical resistance of cooling water (R). The units are omitted in FIG. 5 because it is a comparative graph.

As evident from FIG. 5, the electroconductivity of the cooling water of the fuel cell power generators in accordance with the present invention was maintained at a low level for a longer period of time than that of the conventional fuel cell power generator.

According to the present invention, it is possible to prevent an abrupt increase in the electroconductivity of the cooling water for a long period of time and the corrosion of the electronic conductive portions contacting the cooling water by electrically insulating the electronic conductive portions contacting the cooling water from each other and interrupting the flow of the cooling water. Accordingly, the fuel cell power generator in accordance with the present invention is suitable for use in home cogeneration systems, power generators for vehicles, etc.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

What is claimed is:

1. A fuel cell electric power generator comprising:
a fuel cell stack;
a cooling medium path in fluid connection with the fuel cell stack for containing a cooling medium;
a heat exchanger in contact with the cooling medium path for removing heat from the cooling medium; and
a circulating system for circulating the cooling medium through the cooling medium path;
wherein at least two of the fuel cell stack, cooling medium path, heat exchanger or circulating system are electrically insulated from each other.

2. The fuel cell electric power generator in accordance with claim 1, wherein the fuel cell stack comprises a stack of unit cells, a pair of current collectors and a pair of end plates, each of the unit cells comprising a hydrogen ion conductive electrolyte membrane, a pair of electrodes sandwiching the hydrogen ion conductive electrolyte membrane and a pair of separators sandwiching the electrodes.

3. The fuel cell electric power generator in accordance with claim 1, wherein the heat exchanger has a heat removing path connected thereto and a heat exchanging plate for recovering heat from the cooling medium flowing in the cooling medium path.

4. The fuel cell electric power generator in accordance with claim 1, wherein the fuel cell stack comprises electrically conductive separators, current collectors and end plates, and the heat exchanger comprises an electrically conductive heat exchanging plate.

5. The fuel cell electric power generator in accordance with claim 1, wherein an electrically insulating part is disposed along at least one portion of the cooling medium path.

6. The fuel cell electric power generator in accordance with claim 1, wherein the fuel cell stack is physically attached to the cooling medium path by an electrically insulating material.

7. The fuel cell electric power generator in accordance with claim 3, wherein the heat removing path is connected to a hot water supplier or hot water storage tank.

8. The fuel cell electric power generator in accordance with claim 7, further comprising an electric leakage prevention means for preventing an electric short between the fuel cell stack and the heat removing path.

9. The fuel cell electric power generator in accordance with claim 8, wherein the electric leakage prevention means is an electrical connection between the heat exchanging plate and ground.

10. The fuel cell electric power generator in accordance with claim 8, wherein the electric leakage prevention means is an electrical connection between the heat removing path and ground.

11. A fuel cell electric power generator comprising:
a fuel cell stack comprising a stack of unit cells, a pair of current collectors and a pair of end plates, each of the unit cells comprising a hydrogen ion conductive electrolyte membrane, a pair of electrodes sandwiching the hydrogen ion conductive electrolyte membrane and a pair of separators sandwiching the electrodes;
a cooling medium path for circulating a cooling medium inside the fuel cell stack;
a heat exchanger in contact with the cooling medium path and having a heat removing path connected thereto and a heat exchanging plate for recovering heat from the cooling medium;
a circulating system for circulating cooling medium through the cooling medium path; and
an interruption unit for interrupting a flow of the cooling medium disposed along any portion of the cooling medium path.

12. The fuel cell electric power generator in accordance with claim 11, wherein the interruption unit is disposed at the inlet of the heat exchanger.

13. The fuel cell electric power generator in accordance with claim 12, further comprising a second interruption unit disposed at the outlet of the heat exchanger.

14. The fuel cell electric power generator in accordance with claim 11, wherein the heat exchanging plate is connected to ground.

15. The fuel cell electric power generator in accordance with claim 11, wherein the heat removing path is connected to ground.
